(19) United States
(12) Patent Application Publication
(10) Pub. No.: US 2024/0412302 A1
(43) Pub. Date: Dec. 12, 2024

(54) Organizational Metric to predict business performance based on longitudinal social network analysis

(71) Applicant: Peter A. Gloor, Charlestown, MA (US)

(72) Inventor: Peter A. Gloor, Charlestown, MA (US)

(21) Appl. No.: 18/794,037

(22) Filed: Aug. 5, 2024

Related U.S. Application Data
(63) Continuation-in-part of application No. 17/812,606, filed on Jul. 14, 2022.

(51) Int. Cl. G06Q 50/00; G06Q 10/0637

(52) U.S. Cl. CPC G06Q 50/01; G06Q 10/06375

(57) ABSTRACT

A system and procedure is described to introduce “entanglement”, a metric to measure how synchronized communication is between team members. This measure employs a computing device to calculate the Euclidean distance among team members' social network metrics time series which is validated with four case studies. The first case study uses entanglement of 11 medical innovation teams to predict team performance and learning behavior. The second uses a computer to analyze the e-mail communication of 113 senior executives, predicting employee turnover through lack of entanglement of an employee. The third case uses a computer to analyze the individual employee performance of 81 managers. The fourth case study uses a computer to predict performance of 13 customer-dedicated teams by comparing entanglement in the e-mail interactions with satisfaction of their customers measured through NPS. Entanglement is a computer-generated metric providing a new versatile indicator analyzing the hitherto underused temporal dimension of online social networks as a predictor of employee and team performance, employee turnover, and customer satisfaction.

This application is a continuation-in-part of U.S. patent application Ser. No. 17/812,606, filed by Peter A. Gloor on Jul. 14, 2022, said application incorporated herein in its entirety.

### COPYRIGHT NOTICE

A portion of the disclosure of this patent document contains material that is subject to copyright protection. The copyright owner has no objection to the xerographic reproduction by anyone of the patent document or the patent disclosure in exactly the form it appears in the Patent and Trademark Office patent file or records, but otherwise reserves all copyright rights whatsoever.

### BACKGROUND

### Field of the Invention

The present invention relates generally to computer-generated social network analysis mechanisms, and more particularly to methods and a computer-based apparatus for a new organizational metric to predict business performance based on longitudinal social network analysis.

### Description of the Related Art

Albert Einstein called quantum entanglement “spooky action at a distance” (Einstein et al., 1935), predicting that quantum mechanics should allow objects to influence each other's action at great distance. It took other Nobel prize winning physicists decades after Einstein's death to confirm his prediction. The current study proposes a similar social entanglement effect between people.

“You share everything with your bestie. Even brain waves.” (Angier, 2018). This is how the New York Times summarized the work of Parkinson et al. (2018), who found that brain scans of close friends show similar patterns as they watch a series of short videos. Using these results, the researchers trained a computer algorithm to predict the strength of a social bond between two people based on the relative similarity or synchronization of their neural response patterns. Such neural synchronization patterns are also observed in various other studies in different contexts, e.g., to determine neural contingencies between musical performers and their audiences. Hou et al. (2020) assess the neural synchronization between violinist and audience and the relation to the popularity of violin performance. Their findings suggest that neural synchronization between the audience and the performer might serve as an underlying mechanism for the positive reception of musical performance. Further, neural synchronization can be confirmed by analyzing verbal group communication (Liu et al., 2019). Individuals try to achieve neural and body synchronization in order to facilitate fluid interaction (Fairhurst et al., 2013; Yun et al., 2012). Experiments show that synchrony of fingertip movement and neural activity between two persons increases after cooperative interaction (Yun et al., 2012).

Hence, engaging individuals in synchronized activities like walking, dancing, etc. is an effective way of increasing subsequent cooperation between those individuals. However, the studies mentioned above focus on neural or body synchronization and are not applied in typical work environments or contexts. However “being in sync” or “in flow” in work environments is a relevant research topic and should be considered by decision-makers to determine the impact of such behavior on employee performance.

However, there exist opportunities to analyze online communication data in near-real time for continuous monitoring of team learning and performance. Metrics based on communication flow from person to person or the amount of communication are suitable for real-time processing. In addition, studies have shown that analyzing online communication data in organizational contexts (de Oliveira et al., 2019; Gloor et al., 2017b) could be used as a predictor for job-related constructs, such as employee turnover or employee performance. The speed of responding to an e-mail, for example, is a good predictor of individual and team performance (Gloor et al., 2020). It might be a proxy for the passion of the person who is responding to an e-mail (Gloor, 2017), or for other external reasons such as urgency, power differentials, etc.

There are multiple teachings that have been disclosed to facilitate the Team synchronization and flow state but unfortunately, there is not a straightforward study and solution proposed in this domain.

The current inventions propose a sophisticated system where a structured methodology is introduced to answer these questions by introducing a metric called entanglement, which measures the synchronization of e-mail communication behaviors of team members and their flow state over time. This metric is grounded in SNA and identifies the similarity of the time series of SNA metrics. The metric is validated by conducting four case studies, with different datasets from different organizations. Each case study is in a different context and variants of the entanglement measure are used as a predictor of different individual and group performance indicators

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary object of the invention is related to an advancement of a computer-based novel metric to measure how synchronized communication between team members is.

It is further the objective of the invention to provide a computer-based structured approach to calculate the Euclidean distance among team members' social network metrics time series.

It is also the objective of the invention to promote a new and versatile indicator for automatic computer-based analysis of employees' communication, analyzing the hitherto underused temporal dimension of online social networks which could be used as a powerful predictor of employee and team performance, employee turnover, and customer satisfaction.

It is also the objective of the invention to provide a novel computer-generated synchronization metric, called entanglement, which is based on computer-generated SNA of e-mail communication between different actors.

It is again the objective of the invention to provide an easy and simple computer-generated metric entanglement that can also predict individual employee turnover and might help such studies to improve their prediction model quality.

It is also the objective of the invention to provide a computer-generated Gini coefficient of betweenness entanglement, which is automatically calculated from time series of betweenness centrality of each employee in the email network, demonstrating that it is associated with individual employee performance. A high Gini index of betweenness entanglement—indicating that an employee is strongly entangled with a small team, while being weakly entangled with the rest of the organization—significantly increases the chance of being a top performer.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims

### BRIEF DESCRIPTION OF DRAWINGS

The following non-limiting and non-exhaustive embodiments of the present invention are described with reference to the following drawings. The system and method of the present invention will now be described with reference to the accompanying flow chart drawing figure, in which:

FIG. 1 shows that Work-related flow leads to better productivity and performance as per preferred embodiments of the invention.

FIG. 2 shows the communication activity of three persons by time as per preferred embodiments of the invention.

FIG. 3 illustrates the direction of an edge specifying the source (e-mail sender) and target (e-mail receiver) node; the weight of an edge shows the relation intensity (number of e-mails) between two nodes as per preferred embodiments of the invention.

FIG. 4 shows the e-mail communication activity of different people with the owner of the mailbox over a period of time, as per preferred embodiments of the invention.

FIG. 5 gives an intuitive motivation for the usefulness of group betweenness entanglement as per preferred embodiments of the invention.

FIG. 6 illustrates the Entanglement correlation with performance as per preferred embodiments of the invention.

FIG. 7 illustrates the Entanglement correlation with learning behavior as per preferred embodiments of the invention.

FIG. 8 illustrates the communication activity over time as per preferred embodiments of the invention.

FIG. 9 illustrates the SHAP values (prediction of leavers) as per preferred embodiments of the invention.

FIG. 10 illustrates SHAP values (prediction of top performers) as per preferred embodiments of the invention.

FIG. 11 illustrates the system architecture of the computer system calculating the entanglement

FIG. 12 illustrates the process of how a computer calculates the entanglement metrics in an organization to predict outcomes

FIG. 13 illustrates the detailed process of how entanglement is calculated by a computer.

FIG. 14 illustrates an aspect of the subject matter in accordance with one embodiment.

Skilled artisans will appreciate that elements in the figures are illustrated for simplicity and clarity and have not necessarily been drawn to scale. For example, the dimensions of some of the features in the figures may be exaggerated relative to other elements to improve understanding of embodiments of the present invention. The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

The current invention in its preferred embodiment aims to provide a sophisticated system based on the idea of using structured communication data to measure different categories of individual and organizational performance.

Synchronization is a fundamental element of life. Besides neuronal synchronization mentioned in the introduction, one finds studies that deal with the synchronization of human activities (Guastello and Peressini, 2017). Synchronization is often defined as the manifestation of unintended coordination. It is part of the natural behavior of a human being and takes place so invisibly that we usually do not notice it. It is triggered by audio-visual stimuli, haptic perception, or simply by the presence of certain people. Synchronization can be analyzed as neuromuscular coordination, where there is a relatively exact or proportional tracking of body, hand, and head movements, autonomic arousal, or electroencephalogram (EEG) readings between two or more people (Guastello and Peressini, 2017). For example, N'eda et al. (2000) show that the audience of a concert synchronizes its applause after an asynchronous start and Fairhurst et al. (2013) and Yun et al. (2012) show that people synchronize their finger tapping to improve coordination. While these studies only look at synchronization as neuromuscular coordination and task coordination, there are research efforts currently underway to uncover connections between synchronization in cognition, task structures, and performance outcomes in teams (Gipson et al., 2016). Better work performance outcomes would also be expected when teams are similarly synchronized (Elkins et al., 2009; Stevens et al., 2013). The hypothesis that team synchronization leads to better performance is further motivated by the theory of flow state. While the concept of synchronization in the above-mentioned studies applies a natural science perspective, human sciences like positive psychology consider synchronization as a part of the flow state (Gloor et al., 2012) and expect the flow state to cause better performance. A team is in the flow state (Csikszentmihalyi, 1996) when members create a sense of shared confidence and empathy, which culminates in a collective mental state in which individual intentions harmonize and are in-sync with those members of the group. This condition is also referred to as achieving a “group mind”, which is marked by a deep emotional resonance that enables e.g., jazz musicians to be completely coordinated throughout the improvisational flow. In other words, group flow manifests itself in physical and verbal activities, for instance, people mirroring each other and quickly finishing each other's sentences using the same words and phrases, indicating a “parallel synchronization of thought” (Armstrong, 2008). The more the team members are in-sync, the more likely it is to observe group flow.

Group flow can be analyzed by applying “interaction analysis”, which entails closely observing and categorizing the interactions, movements, and body language of group members. However, it cannot be limited to neurological studies of particular participants of the group's emotional conditions or subjective memories (Sawyer, 2003). Thus, group flow cannot be split down into specific tasks; rather, it is a process that arises from group dynamics and has the ability to improve job satisfaction, intrinsic motivation, vigor, performance, or efficiency (Delarue et al., 2008; Sawyer, 2003; van den Hout et al., 2018). Hence, flow represents rather an oscillating dynamic state that combines continuous and sudden changes across time (Ceja and Navarro, 2012) than a static one.

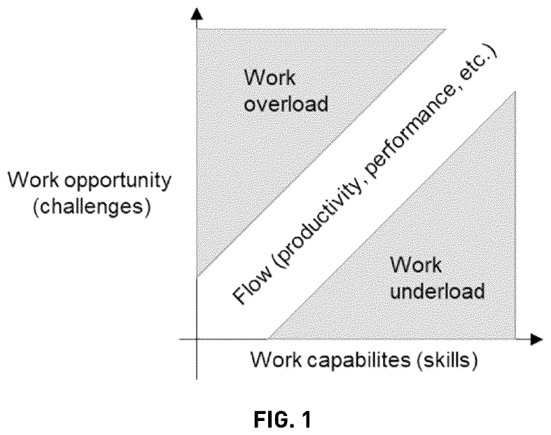

The flow concept can be transferred into the organizational context (Heyne et al., 2011). Bakker (2005) defines work-related flow as a short-term peak experience at work that is characterized by absorption, work enjoyment, and interest. Teams “are in flow” if there is a certain balance between challenges and the skill sets of the individual team members. Work-related flow leads to better productivity and performance (see FIG. 1). Further, by the definition of flow by Csikszentmihalyi (1996) high flow leads to high performance. If a team is collectively in flow, it therefore will deliver high performance. In general, flow is likely to correlate positively with measurable results (Quinn, 2005). Quinn (2005, p. 611) emphasizes that “[i]n knowledge work [ . . . ] flow may be a useful concept for understanding performance.”. Studies of flow proceed from a broader awareness that team processes like communication need to be studied as events over time (Arrow et al., 2004).

Each team member, or individual, may have a computing identifier to identify the member in the computing environment.

### Entanglement Conceptualization and Formalization

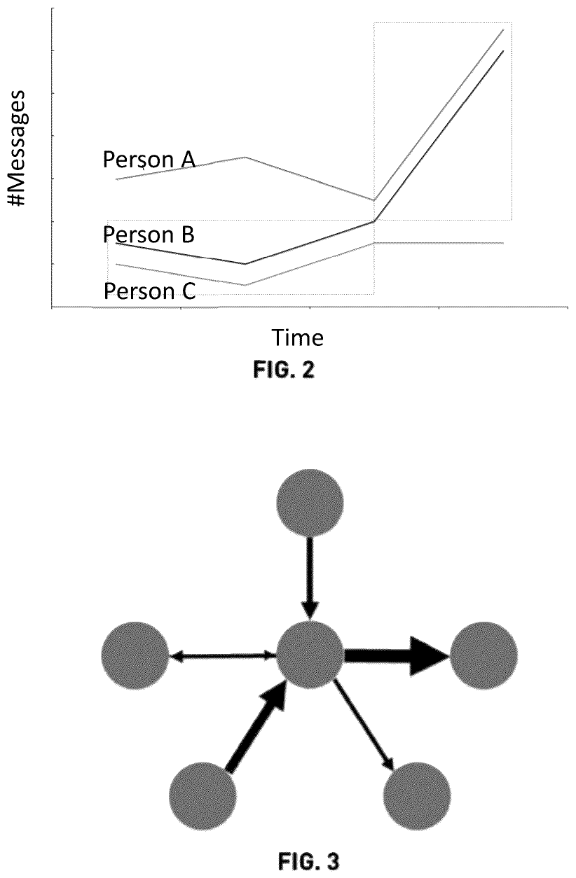

The idea of the entanglement measure is to determine how a person is in sync with his/her group and shares the same flow with the other team members, with regard to communication over a period of time. In an attempt to conceptualize entanglement, a multidisciplinary approach is proposed, bringing together concepts from several disciplines, ranging from quantum mechanics to human and social sciences. A result of this phenomenon is that when one measures the quantum state of one particle, one simultaneously determines the quantum state of the other particle. A quantum state (of a particle) is a representation of knowledge or information about an aspect of the system or reality (Pusey et al., 2012). In this study, we interpret the reality as the state about a person-to-person relationship. Thus, the two particles are seen as two individuals that have potentially interacted with “others”, not necessarily with each other, and have therefore become entangled. Our idea of synchronicity is that people are in-sync when they show similar behavioral patterns, such as communication activity. Hence, two persons are entangled even when they are physically separated or not involved in a (local) interaction with each other but share a similar communication behavior (an example is provided in FIG. 2).

Similar concepts have previously been described in psychology and sociology. “Entrainment” describes a process where one system's motion or oscillation frequency synchronizes with another system, for instance, the brainwaves of two people rocking together in their chairs. Cross et al. (2019) defines interpersonal entrainment as the synchronization of organisms to a rhythm, for example singing, dancing, or even walking together. Much earlier, early twentieth-century French sociologist Emile Durkheim defined collective effervescence as the similar but broader notion of synchronized action between humans (Durkheim, 2008), to describe when a community or society comes together to communicate the same thought or participate in the same action. This concept has been picked up by sociologist Randall Collins through his construct of “Interaction Ritual Chains” (Collins, 2005), which explain collective action through shared emotional energy. The common theme of all these constructs is colocation, people creating and experiencing emotional energy by being together at the same location. We therefore prefer the term “entanglement” to describe synchronous action between humans independent from where they are located, to describe in the words of Albert Einstein, “spooky action at a distance”.

Human communication is fundamentally synchronous and rhythmic, two important characteristics of individual and interactional behavior (Condon, 1986). The synchronization of interactional behaviors helps to generate a sense of flow state for the persons involved (Condon, 1986). Further, it always takes other people for a person to reach the state of flow (Collins, 2005), while the other people do not have to be physically present. Thus, entanglement leads to a flow state of two persons analogous to the “mysterious change” of a particle's quantum state. Intuitively, we propose that the “more similar the communication” of two persons A and B is, the more person A is in sync and is able to share the same flow of communication with person B over a period of time. Individuals who are in flow might have higher abilities to productively channel their cooperative spirit when working together.

FIG. 2 shows the communication of three persons by time. Person B and C communicate in similar intensity (here: number of sent messages) from t1 until t3. Their communication decreases from t1 to t2 and increases from t2 to t3 by the same amount. Further, their lines in the chart are very close together meaning the distance between each of their data points is short. We observe the same pattern for person A and person B in time periods t3 and t4. Such patterns might indicate synchronization.

Thus, we can state that the distance of the data points representing the communication intensity between two or more persons in a specific time window is an indicator of their synchronization. Here, we use the Euclidean distance, a straight-line distance between two points in Euclidean space. We calculate the Euclidean distance d of two data points x and y of a communication metric A of the same time window t with:

$$d ( A ( {x}_{t} ) , A ( {y}_{t} ) ) = \sqrt{{( A ( {x}_{t} ) - A ( {y}_{t} ) )}^{2}}$$

This Euclidean distance specified in the formula above is calculated for every pair of nodes and time window t. An essential requirement to determine if persons are entangled is to consider both team synchronization and team flow. Team flow is based on flow experienced in relational embeddedness (Burt, 2005) which can be established by e.g., communication and collaboration. To address this structural feature of communication, we propose to apply SNA. SNA offers a suitable methodology to study group dynamics as well as to investigate the role of the individuals within these dynamics (Wasserman and Faust, 1994). It focuses on various aspects of the relational structures and the flow of information, which characterize a network of people, through graphs and structural measures.

To better illustrate the concept of “entanglement” we consider an email network, characterized as a graph made of a set of nodes (e-mail accounts) and a set of directed edges (weighted by the number of emails) connecting these nodes. The direction of an edge specifies the source (e-mail sender) and target (e-mail receiver) node; the weight of an edge shows the relation intensity (number of e-mails) between two nodes (see FIG. 3). For example, if person A sends 3 emails to person B, we see an arc originating at node A and terminating at node B of weight equal to 3.

To illustrate the idea and calculation of entanglement with an example, we use an individual mailbox representing a dataset of e-mails of persons who work together on several projects. First, we collected the mailbox and stored it in a database, where the e-mail data was structured from a network perspective. In order to calculate the entanglement of the mailbox owner and his/her colleagues, we take the inverse of the Euclidean distance of the time series of the communication activity represented by messages sent over time for each node/actor in the network. This value will get larger the more similar the activity time series of the two actors are. However, we have to distinguish between two pairs of actors at different locations in the network, one pair embedded into a tight cluster communicating with many other actors, while the other pair is exchanging the same number of e-mails as the first pair, but is only weakly connected to other actors. To make this metric comparable among pairs of actors with different levels of activity in the same network, we multiply it by the product of the degree centralities of both actors. Degree measures the centrality, sometimes seen as a proxy of popularity, of a node in a network, by counting the number of its nearest neighbors (Freeman, 1978).

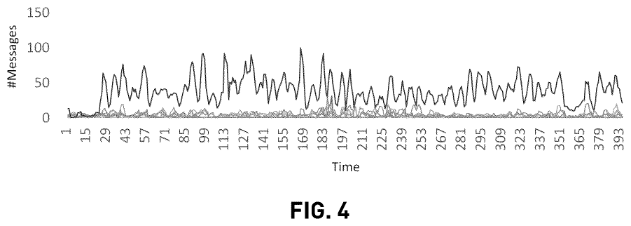

Further, it can be a proxy for the level of engagement within a group, team, or organization (Gloor et al., 2020). Communication activity via e-mail (Gloor et al., 2014) indicates the number of e-mail messages sent by a person within a time interval. FIG. 4 shows the e-mail communication activity over a period of time, for the email box we analyzed. The blue line shows the mailbox owner's communication activity, the other lines correspond to the people s/he is exchanging e-mails most frequently with. The more correlated the communication activity between the owner of the mailbox and another person are, the more they are in sync, share the same flow over a period of time, and thus are entangled. The picture also illustrates the need to include degree centrality in the entanglement formula, as the levels of activities, while running in parallel, are vastly different for different people.

Accordingly, we define the activity entanglement EA (xT, yT) between two individuals, named x and y in a specific time window T, as:

$${E}_{A} ( {x}_{T} , {y}_{T} ) = \frac{{C}_{D} ( {x}_{T} ) {C}_{D} ( {y}_{T} )}{d ( A ( {x}_{T} ) , A ( {y}_{T} ) )}$$

where CD (xT) and CD (yT) are the degree centralities of the two individuals x and y, and d(A(xT), A(yT)) is their Euclidean distance, with respect to communication activity A in a defined time window T. In other words, the entanglement of two individuals x and y is given by the multiplication of the number of their direct contacts in the e-mail network divided by their synchronization of communication activity. As has been said above, it is necessary to include the product of the degree centralities of x and y into the entanglement formula to provide for the differences in centralities between actors: assume that actor x has low degree, if x is synchronized with highly connected actor y having high degree centrality, the high degree of actor y will boost entanglement of actor x in comparison with all other actors in the network. In other words, we want our metric to reward less influential actors who are synchronized with influential actors.

Similarly, we could consider not just communication activity, but also individuals' synchronization in weighted and unweighted betweenness centrality. Betweenness is a well-known metric in social network analysis. It is the sum of the fraction of all-pairs shortest paths that pass through a node v (Freeman, 1977):

$${C}_{B} ( v ) = \text{?} \frac{σ ( s , t \vert v )}{σ ( s , t )} ,$$

$$\text{?} \text{indicates text missing or illegible when filed}$$

where V is the set of nodes, σ (s, t) is the number of shortest paths from s to t, and σ (s, t|v) is the number of those paths passing through node v (Brandes, 2001). Inverse arc weights are considered for the determination of node distances. To control for network size, the above index is usually normalized between zero and one.

If the betweenness centrality time series of two individuals are in sync, it means that they share similar network positions, and levels of influence, at the same time. Individual betweenness entanglement EB is the product of the degree of two individuals divided by their Euclidean distance in betweenness centrality over a period of time.

$${E}_{B} ( {x}_{T} , {y}_{T} ) = \frac{{C}_{D} ( {x}_{T} ) {C}_{D} ( {y}_{T} )}{d ( {C}_{B} ( {x}_{T} ) , {C}_{B} ( {y}_{T} ) )}$$

In addition, we speculate on the possibility of evaluating how much an individual is in sync with the aggregated flow of the entire network. As a proxy of the aggregated rhythm of the team, we take Freeman's group betweenness centralization, CGB (Freeman, 1978). Group betweenness centralization is the sum of the differences between the betweenness centrality of the most central node, CB(v*), and that of all other nodes in the network (Freeman, 1978; Wasserman and Faust, 1994), normalized by its maximum value which is (G−1)²(G−2) where G is the total number of nodes:

$${C}_{GB} = \frac{2 {\sum }_{i = 1}^{G} [ {C}_{B} ( {v}^{*} ) - {C}_{B} ( {v}_{i} ) . ]}{{( G - 1 )}^{2} ( G - 2 )} .$$

This definition of group betweenness centralization is appropriate for this use case, as we compare how entangled an individual node is with all other nodes with regard to betweenness.

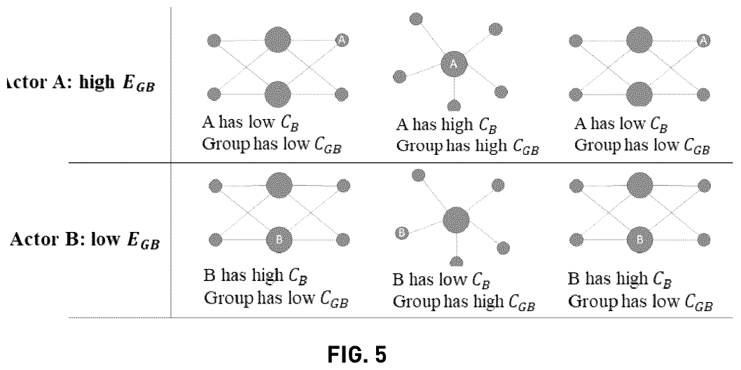

FIG. 5 gives an intuitive motivation for the usefulness of group betweenness entanglement. It shows a group of six actors at three points in time of a changing network structure. Actor A is very much “entangled” with the overall group: In t1 and t3, when the group betweenness centralization (CGB) is low, his/her (individual) betweenness centrality (CB) is low also, in t2, when the group betweenness centralization is high, his/her CB is high too, leading to low Euclidean distance of his/her CB to CGB, resulting in high entanglement. In contrast, actor B is lowly “entangled” with the group, in t1 and t3 when CGB is low, his/her betweenness centrality (CB) is high, in t2 when CGB is high, his CB is low. This leads to a high Euclidean distance to CGB, and thus to low entanglement.

Formally, we measure group betweenness entanglement EGB by dividing group betweenness centralization CGB by the Euclidean distance of group betweenness centralization and normalized betweenness centrality of the actor being analyzed over a time period. CGBT—as a metric of variation—is an indicator for the centralization of the group in time window T, the individual betweenness centrality CB (xT) in this sense is an influence on CGBT, i.e., how much an actor impacts CGBT. Intuitively, this metric reflects the contribution of this actor to the level of centralization of its group. In other words, it measures how far away the normalized betweenness centrality of an actor is from the betweenness centralization of its group at any point in time. If an actor's betweenness is high and its group betweenness centralization is high, the actor is probably responsible for the centralized network structure-thus the Euclidean distance between group betweenness centralization and an actor's betweenness centrality is small, and therefore the actor's group betweenness entanglement high. On the other hand, if an actor's betweenness is low and its group betweenness centralization is high, it means somebody else is central and the actor is unimportant in betweenness centrality terms, thus less entangled with the group.

betweenness entanglement, E_{GB}(x_{T}) of x as:

$${E}_{GB} ( {x}_{T} ) = \frac{{C}_{{GB}_{r}}}{d ( {C}_{B} ( {x}_{T} ) , {C}_{{GB}_{r}} )}$$

To show the inequality in individual group betweenness entanglement we calculate the Gini coefficient for EGB:

$$G ( {E}_{GB} ) = \frac{{\sum }_{i = 1}^{n} {\sum }_{j = 1}^{n} \vert {E}_{GB} ( {x}_{i} ) - {E}_{GB} ( {x}_{j} ) \vert}{2 {n}^{2} \overline{{E}_{GB}}}$$

The same formula can also be used for activity entanglement to calculate G(E_{A}). Intuitively, the Gini coefficient measures inequality in the distribution of entanglement among all actors in a network. This is based on the observation that for an actor x being resource-poor or resource-rich in a network—the resource being entanglement in this case—can be highly predictive for the behavior or performance of x. It therefore makes sense to put the entanglement of x in relationship to the entanglement of all other actors in the network through Gini entanglement.

This is illustrated by four case studies (Table 1) that show how the proposed entanglement metric can be used with e-mail data to predict work-related outcome variables, such as team performance and employee turnover. The four cases are related to different business contexts and consider different dependent variables. In all cases we analyze email data, illustrating the suitability of the entanglement metric for online communication data. Our goal here is not to directly compare results across case studies, deriving general conclusions, or claiming causality. Rather we want to show the versatility of our entanglement metrics, which can be adapted to study business interaction dynamics in different scenarios.

TABLE 1
Case studies overview.

| Case | | Research | Entanglement | Entanglement | Outcome |
|---|---|---|---|---|---|
| study | [symbol] | objects | [symbol] | [symbol] | variable |
| A | Health care | 53 employees in | Activity | Team | Team performance & learning |
| | | 11 healthcare | entanglement | | behavior |
| | | innovation teams | | | |
| B | Professional | 113 senior | Activity | Individual | Employee turnover |
| | services | executives | entanglement | | |
| C | Professional | 81 managers | Betweenness | Individual | Employee performance |
| | services | | entanglement | | |
| D | Professional | 82 managers | Group [symbol] | Team | Customer satisfaction |
| | services | in 13 teams | entanglement | | |

Table 1 - the case studies overview. [symbol]
indicates data missing or illegible when filed

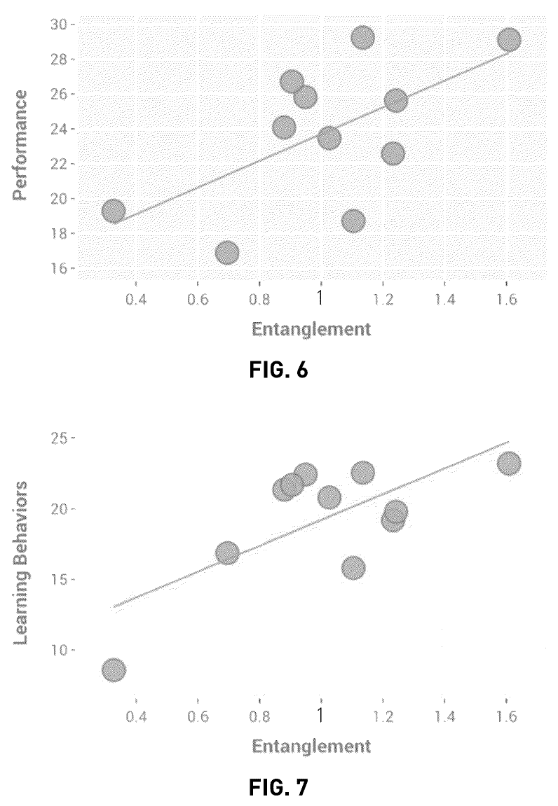

Case study A—learning behavior and performance: This case study was conducted as a pilot in a healthcare organization to determine if activity entanglement E_{A} between 53 team members of 11 medical innovation teams could predict performance and learning behaviors. The performance and learning behaviors of each team were rated and triangulated every other month for the duration of a year by three overall project managers. They individually rated the team performance and the capability of the team to learn new things. At the same time, all e-mails of the project members were collected and analyzed. Individual activity entanglement of each actor with all other actors was calculated, and then the average was taken for each actor. Finally, for each team average and standard deviation of activity entanglement over all team members were computed. We find that team performance and learning behavior are significantly correlated with the standard deviation of activity entanglement of team members, as shown in FIG. 6 and FIG. 7 (which show a scatter plot of the two metrics, with a fitted regression line). The Pearson's correlation coefficient of the standard deviation of activity entanglement of team members with team performance is 0.615 (p=0.045) and with learning behavior is 0.707 (p=0.015). In other words, the wider the spread in activity entanglement E_{A} of the team members, the higher their performance and learning behavior. This pattern corresponds to a few core team members being strongly entangled, and the remaining members showing weak E_{A}. We also notice that moderate dispersion of entanglement is associated with a higher variability in performance scores. This could be explained by control variables we could not collect in this study due to limited data availability. Alternatively, it could suggest that in order for performance to be high, few employees have to take a strong group lead, guiding the others towards a common goal.

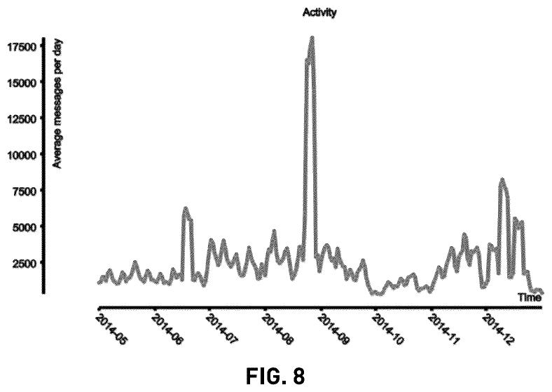

Case study B—turnover prediction: In our second case study, we conducted a pilot study at a global professional services firm. In this case, we wanted to evaluate the possible association of entanglement with executives' decision to leave the firm, through voluntary resignation. Turnover of highly important employees such as senior executives is critical for companies, because it has negative implications for firm performance (Hancock et al., 2013; Zylka and Fischbach, 2017). Eight months of e-mail data of 113 senior executives at a large global services company was collected from May to December 2014 (see FIG. 8). We calculated activity entanglement E_{A} of 55 employees who left the firm from January to May 2015. To determine the inequality in entanglement, we also calculate the Gini index of E_{A}, for each person (from an ego perspective) in the network, considering her/his entanglement and that of all other peers. The Gini index measures the dispersion of entanglement scores of a social actor with all others in the network. In an “egalitarian” network with a low Gini index for each node, all actors are either highly or weakly entangled, in a “non-egalitarian” network with a high Gini index some actors are highly entangled, while others are weakly entangled. This was compared with the activity entanglement E_{A} of a control group made of 58 employees, who were selected randomly and still working in an unterminated position at the firm in June 2015.

From a preliminary t-test, we immediately notice that there is a significant difference in the Gini index of activity entanglement, between senior executives who leave the company (M=0.0457, SD=0.0070) and those who stay (M=0.0488, SD=0.0059), t(111)=−2.513, p=0.0013. On average, Gini entanglement is significantly higher for those who stay.

Past studies have shown that managerial disengagement might depend on multiple factors and that communication-based and social network analysis metrics, captured from e-mail communication, can reveal it (Gloor et al., 2017b). Accordingly, we present Pearson's correlations (in Table 2) and logistic regression models (in Table 3), to see if the effect of the entanglement variable remained significant when combined with other predictors. The highest correlation of entanglement is with the contribution index, which however does not lead to collinearity issues. A high contribution index is an indication of “spammers”, the higher the contribution index, the more somebody sends compared to receiving e-mail. If there is a spammer, s/he will be entangled with many, while others who are sending much less, will thus be less entangled. This results in a high Gini entanglement for that person. Extending this effect to all users will lead to high correlation between the two values.

TABLE 2
Correlations for leavers [symbol]
Table 2 - the correlation for leavers.

| | | 1 | 2 | 3 | 4 | 5 | 6 | 7 | 8 | 9 | 10 | 11 | 12 |
|---|---|---|---|---|---|---|---|---|---|---|---|---|---|
| 1 | Leaver (1 = yes) | 1 | | | | | | | | | | | |
| 2 | Rank | [symbol] | 1 | | | | | | | | | | |
| 3 | Tenure | [symbol] | [symbol] | 1 | | | | | | | | | |
| 4 | TSLP | [symbol] | [symbol] | [symbol] | 1 | | | | | | | | |
| 5 | Msg sent | [symbol] | [symbol] | [symbol] | [symbol] | 1 | | | | | | | |
| 6 | Msg received | [symbol] | [symbol] | [symbol] | [symbol] | [symbol] | 1 | | | | | | |
| 7 | CI | [symbol] | [symbol] | [symbol] | [symbol] | [symbol] | [symbol] | 1 | | | | | |
| 8 | Reach 2 | [symbol] | [symbol] | [symbol] | [symbol] | [symbol] | [symbol] | [symbol] | 1 | | | | |
| 9 | Betweenness | [symbol] | [symbol] | [symbol] | [symbol] | [symbol] | [symbol] | [symbol] | [symbol] | 1 | | | |
| 10 | Alter ART | [symbol] | [symbol] | [symbol] | [symbol] | [symbol] | [symbol] | [symbol] | [symbol] | [symbol] | 1 | | |
| 11 | Ego ART | [symbol] | [symbol] | [symbol] | [symbol] | [symbol] | [symbol] | [symbol] | [symbol] | [symbol] | [symbol] | 1 | |
| 12 | Gini entanglement | [symbol] | [symbol] | [symbol] | [symbol] | [symbol] | [symbol] | [symbol] | [symbol] | [symbol] | [symbol] | [symbol] | 1 |

[symbol]

p < [symbol] [symbol]
p < [symbol] [symbol]
indicates data missing or illegible when filed

TABLE 3
Logistic regression for leavers.

| Variable | Model 1 | Model 2 | Model 3 | Model 4 | Model 5 |
|---|---|---|---|---|---|
| Rank | 0.40740 | 0.30430 | 0.06247 | 0.32153 | 0.10214 |
| Tenure | 0.00146 | 0.00184 | 0.00094 | −0.00039 | 0.00403 |
| TSLP | −0.00080 | −0.00004 | 0.00012 | 0.00036 | 0.00148 |
| Msg sent | | 0.00007 | −0.00036 | −0.00047 | −0.00033 |
| Msg received | | 0.00013 | 0.00049 | 0.00056 | 0.0016226** |
| CI | | −0.91878 | −0.76631 | −0.23275 | 3.326418** |
| Reach 2 | | | −0.00017 | 0.00074 | 0.00037 |
| Betweenness | | | 0.00004 | 0.00004 | 0.00005 |
| Alter ART | | | | −0.00313 | −0.00891 |
| Ego ART | | | | 0.021418* | 0.0299733 |
| Gini | | | | | −35.02065** |
| entanglement | | | | | |
| Constant | −0.62053 | −1.12106 | −0.72954 | −1.64071 | 16.28513** |
| Pseudo R- | 0.00470 | 0.02930 | 0.04970 | 0.08420 | 0.17960 |
| squared | | | | | |

*p < .05;
**p < .01.
Table 3 - the logistics regression for leavers.

We first tested a model with only the control variables of rank, tenure, and time since the last promotion (TSLP) was measured in months. In the subsequent models, we added the other predictors in blocks showing, in Model 4, that the only significant predictor, before adding entanglement, is Ego ART. This suggests that managers who leave the company are less responsive to e-mails and take more time to answer. In the full model, Ego ART, messages sent, contribution index, and Gini activity entanglement are significant. Including this last predictor in the model leads to a significant improvement of the McFadden's pseudo-R-squared, which more than doubles (going from 0.08 to 0.18). As we can see from Model 5, a higher Gini entanglement makes the probability of leaving the company smaller.

To evaluate the possibility of using the entanglement variable for making predictions, we used machine learning. In particular, we used a tree boosting model named CatBoost and its related Python library (Prokhorenkova et al., 2018). This boosting approach is now well-known and has proven its usefulness in past research, where it also sometimes outperformed other supervised machine learning methods, such as Support Vector Machines (SVM) and Random Forest Models (Huang et al., 2019). The model performance has been assessed through Monte Carlo Cross Validation (Dubitzky et al., 2007), with 300 random splits of the dataset into train and test data (75% vs 25%). Thanks to the contribution of our variables, we could achieve an average accuracy of predictions of 80.25%, with an average value of the Area Under the ROC-Curve (AUC) of 0.81.

In a second step, we considered the average model resulting from cross-validation and used it to interpret the impact of each variable on predictions (calculated as the average of its absolute Shapley values). We used the SHapley Additive explanations (SHAP) Python package (Lundberg and Lee, 2017). This method proved to be particularly suitable for tree ensembles and to work well also with respect to other approaches (Lundberg et al., 2020, 2018). As FIG. 9 shows, the Gini index of activity entanglement is the variable with the highest impact on model predictions. Its contribution is much higher than all other variables, again supporting the importance of this metric. In the second place, we find Ego ART. Results are consistent with those of logit models and indicate that managers who are slower in answering e-mails, and have low Gini entanglement, are more likely to leave the company. Low Gini entanglement means that they show constant levels of entanglement, either being entangled with almost nobody or everyone-a situation that might be stressful to maintain, especially when associated with email overload (Reinke and Chamorro-Premuzic, 2014). Average/high levels of Gini entanglement, on the other hand, have a positive impact on the prediction of staying in the company. This means that these managers show uneven entanglement, being highly entangled with some colleagues while being weakly entangled with others.

Case study C—employee performance: We analyzed the e-mail interactions of 81 managers working for a big international services company. Every year the performance of managers was evaluated by their bosses and by the HR department. Whereas the rating of almost all of these managers was “exceeded expectations” for the year 2015, we noticed that 15 of them obtained a lower rating. Like in the case study B of resigning senior executives, we were interested in understanding if entanglement could be related to individual work performance. Carrying out a t-test, we could see that there is a significant difference between the Gini coefficients of betweenness entanglement EB scores of tops (M=0.0508, SD=0.0061) and low (M=0.469, SD=0.0028) performers, t(79)=2.432, p=0.0017.

As we did for leavers in case study B, we additionally built logistic regression models to assess the combined impact of variables on the probability to be a low performer. Pearson's correlations among our predictors are presented in Table 4. The highest correlation of entanglement is again with the contribution index, but this time lower than case study B.

TABLE 4
Correlations for low performers [symbol]
Table 4 - the correlations for low performers.

| | | 1 | 2 | 3 | 4 | 5 | 6 | 7 | 8 | 9 | 10 | 11 |
|---|---|---|---|---|---|---|---|---|---|---|---|---|
| 1 | [symbol] | 1 | | | | | | | | | | |
| 2 | [symbol] | [symbol] | 1 | | | | | | | | | |
| 3 | TSLP | [symbol] | [symbol] | 1 | | | | | | | | |
| 4 | Msg sent | [symbol] | [symbol] | [symbol] | 1 | | | | | | | |
| 5 | Msg received | [symbol] | [symbol] | [symbol] | [symbol] | 1 | | | | | | |
| 6 | CI | [symbol] | [symbol] | [symbol] | [symbol] | [symbol] | 1 | | | | | |
| 7 | Reach 2 | [symbol] | [symbol] | [symbol] | [symbol] | [symbol] | [symbol] | 1 | | | | |
| 8 | Betweenness | [symbol] | [symbol] | [symbol] | [symbol] | [symbol] | [symbol] | [symbol] | 1 | | | |
| 9 | Alter ART | [symbol] | [symbol] | [symbol] | [symbol] | [symbol] | [symbol] | [symbol] | [symbol] | 1 | | |
| 10 | Ego ART | [symbol] | [symbol] | [symbol] | [symbol] | [symbol] | [symbol] | [symbol] | [symbol] | [symbol] | 1 | |
| 11 | Gini entanglement | [symbol] | [symbol] | [symbol] | [symbol] | [symbol] | [symbol] | [symbol] | [symbol] | [symbol] | [symbol] | 1 |

[symbol]

p < [symbol] [symbol]
p < [symbol] [symbol]
indicates data missing or illegible when filed

As Table 5 shows, in the full model the p-value of Gini entanglement is only <0.1; however, the inclusion of this variable leads to a good improvement of the McFadden's pseudo-R-squared, from 0.2314 (Model 4) to 0.2803 (Model 5). A significant performance improvement is also obtained by including weighted betweenness centrality.

TABLE 5
Logistic regression for low performaners.

| Variable | Model 1 | Model 2 | Model 3 | Model 4 | Model 5 |
|---|---|---|---|---|---|
| Rank | [symbol] | [symbol] | [symbol] | [symbol] | [symbol] |
| Tenure | | | | | |
| TSLP | | | | | |
| Msg sent | | | | | |
| Msg received | | | | | |
| CI | | | | | |
| Reach 2 | | | | | |
| Betweenness | | | | | |
| Alter ART | | | | | |
| Ego ART | | | | | |
| Gini | | | | | |
| entanglement | | | | | |
| Constant | | | | | |
| Pseudo R- | | | | | |
| squared | | | | | |

*p < .10;
**p < .05;
***p < .01;
****p < .001.
Table 5 - Logistic regression for low performers. [symbol]
indicates data missing or illegible when filed

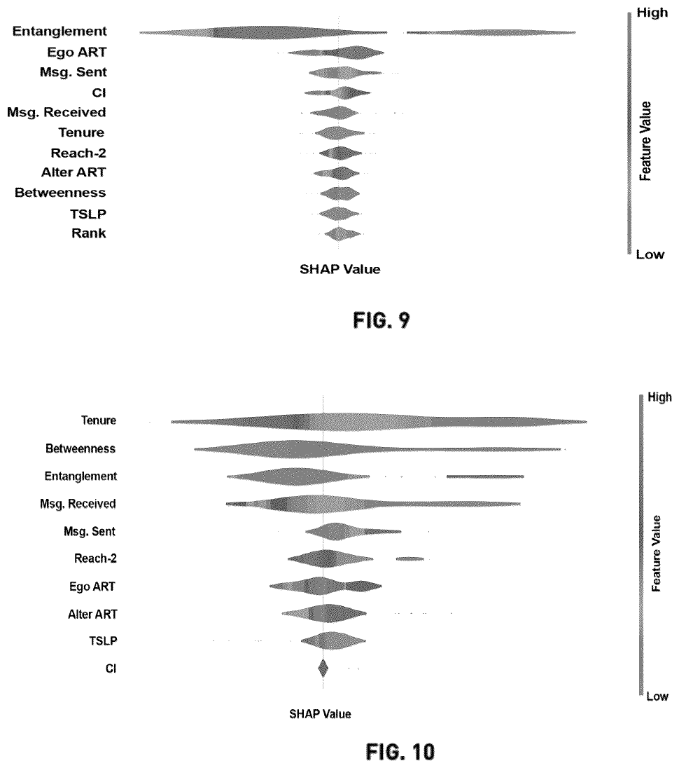

The usefulness of the entanglement predictor is confirmed by the results of the CatBoost model that we trained to classify managers into top and low performers. We followed the same procedure as in the previous case study B—i.e., a Monte Carlo cross-validation with 300 repetitions—and obtained good average results (Accuracy=74.73%, AUC=0.68). FIG. 10 shows the Shapley values associated with each predictor. For an easier reading, we coded top performers as 1 and low performers as 0 (here the model is predicting top performers, which is exactly symmetrical to the choice of predicting low performers that we did in Table 5). Tenure, betweenness, centrality, and entanglement are the most important predictors—with a high Gini coefficient of betweenness entanglement and high betweenness centrality significantly increasing the chance of being classified as a top performer. These managers are highly entangled with some colleagues, and weakly entangled with others—demonstrating selective communication behavior with close collaborators, while being efficient with their time and communicating comparatively less with the rest of the organization. Regarding tenure, we observe the opposite effect, with recently hired employees generally receiving better ratings.

Case study D—Customer Satisfaction: In this case study, we show that entanglement is significantly related to team performance, measured as customer satisfaction through the Net Promoter Score (NPS). 13 teams within the company participated in our study, comprising a total of 82 managers. Each team was dedicated to a specific client.

We measured betweenness entanglement of each team by taking the group betweenness entanglement of each member and considering group dispersion by means of the Gini coefficient.

We find that high group betweenness entanglement inequality is positively related to team performance—this time measured as customer satisfaction. Running a Pearson's correlation test, we find a significant association of the Gini group betweenness entanglement with team performance (r=0.0522, p=0.0002). For each team, we have repeated measures over three time periods. Therefore, we used multilevel linear models (Hoffman and Rovine, 2007; Nezlek, 2008; Singer and Willett, 2009) as a more appropriate technique to evaluate the possible effect of entanglement on customer satisfaction. We nested repeated measures into groups (level 2). Results are presented in Table 6.

TABLE 6
Multilevel models for customer satisfaction (N = 34, with 13 groups),

| | Model 1 | Model 2 |
|---|---|---|
| Gini Group Betweenness | | 0.6418315* |
| Entanglement | | |
| Constant | 0.5244776*** | 0.2869091* |
| Variance L2 | 0.0655537 | 0.0455178 |
| Variance L1 | 0.020654 | 0.0211838 |
| Variance Change L2 | | −30.56% |
| Variance Change L1 | | 2.57% |

Note.
*p < .05;
***p < .001.
Table 6 - The Multilevel models for customer satisfaction (N = 34, with 13 groups).

As the table shows, the biggest variance proportion can be attributed to team characteristics: the intraclass correlation coefficient is 0.7604, meaning that 76% of the empty model variance is at level 2 (Model 1). Including the entanglement variable in the model (Model 2) reduces this variance by 30.56%, which is a highly significant result for a single predictor. The higher the inequality in group betweenness entanglement is, the happier the customer is. Similarly, to case study A, this confirms that selective communication of teams, where some team members are highly entangled and others are not, leads to happier customers.

Table 7 shows the summary of the cases.

TABLE 7
Case study|results summary.

| Case | Dependent | |
|---|---|---|
| study | Variable | Result summary |
| A | Team | The wider the spread in activity |
| | performance | entanglement team members, the |
| | and learning | higher the team performance and learning |
| | behavior | behavior. This corresponds is to having some |
| | | core team members strongly entangled and |
| | | the remaining members weakly entangled. |
| B | Employee | The Gini index of activity entanglement is the |
| | turnover | variable with the highest impact on model |
| | | predictions. Employees who stay in the |
| | | company have high Gini entanglement, |
| | | probably using selective communication and |
| | | interacting more with some colleagues than |
| | | with all others. They are also more responsive |
| | | to emails and take less time to answer. |
| C | Individual | Tenure, betweenness centrality and Gini |
| | performance | entanglement are the most important |
| | | predictors of top performers - with high Gini |
| | | index of betweenness entanglement and high |
| | | betweenness centrality significantly |
| | | increasing the chance of being classified as a |
| | | top performer. |
| D | Customer | The Gini index of group betweenness |
| | satisfaction | entanglement for teams, is related to |
| | | customer satisfaction. The higher the |
| | | inequality in group betweenness |
| | | entanglement is for a team, the happier its |
| | | customer is. This suggests th tat customers are |
| | | happier when a few entangled leaders |
| | | emerge in the team. |

Table 7 - The Case study results summary.

### System Architecture

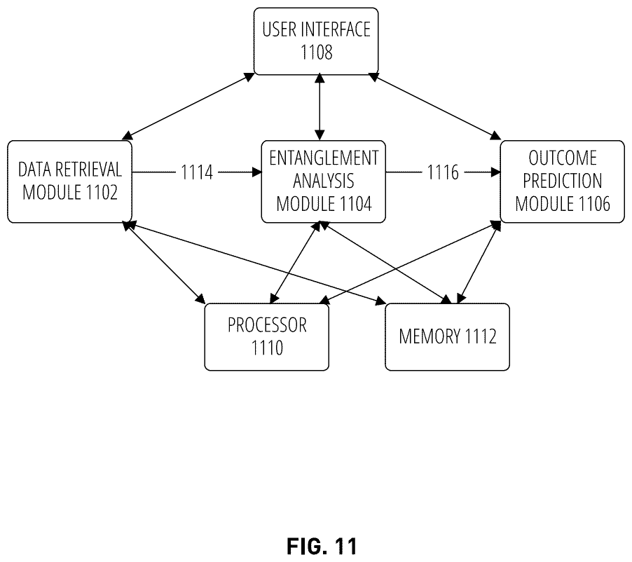

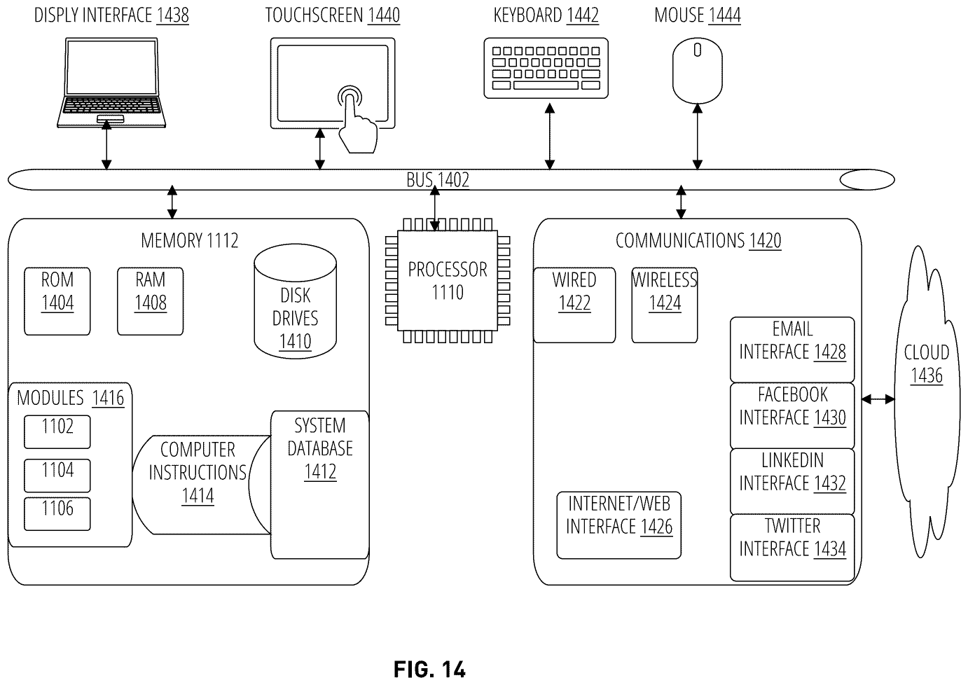

FIG. 11 illustrates the overall system architecture for implementing the entanglement analysis method. The system could operate as a computer-implemented method, as non-transitory computer-readable medium storing instructions that, when executed by a processor, cause the processor to perform a method, an apparatus as shown in FIG. 14, as hardware functions implemented in circuitry or on an ASIC, as a set of functions distributed across a network, or an equivalent. The system comprises:

1) A data retrieval module 1102: This module interfaces with email servers or other communication platforms to collect electronic communication data 1114. It uses secure APIs or database queries to extract relevant metadata such as sender, recipient, timestamp, and message content.

2) An entanglement analysis module 1104: This core component implements the algorithms for calculating entanglement metrics. It processes the raw communication data 1114 to construct social network graphs and compute various centrality measures. This module sends performance measures 1116 to the outcome prediction module 1106

3) An outcome prediction module 1106: This module uses the calculated entanglement metrics along with other relevant data to predict performance outcomes, employee turnover, or other organizational behaviors of interest.

4) A processor 1110: A central processing unit that executes the computations required by the data retrieval module 1102, entanglement analysis module 1104, outcome prediction module 1106, and other modules.

5) Memory 1112: Both volatile (RAM) and non-volatile (e.g., SSD) storage for holding data and program instructions, including instructions for the data retrieval module 1102, entanglement analysis module 1104, and outcome prediction module 1106. Memory 1112 also holds the system's database.

6) User interface 1108: A graphical interface for displaying results and allowing user interaction with the system. The User interface 1108 may show the results from the outcome prediction module 1106 and may collect parameters for the data retrieval module 1102.

The modules interact as follows: The data retrieval module 1102 periodically collects new communication data 1114 and stores it in the system's database. The entanglement analysis module 1104 processes this communication data 1114 to calculate up-to-date entanglement metrics, called performance measures 1116. The outcome prediction module 1106 then uses these metrics, along with other relevant data, to generate predictions or insights. Results are presented to users through the graphical User interface 1108.

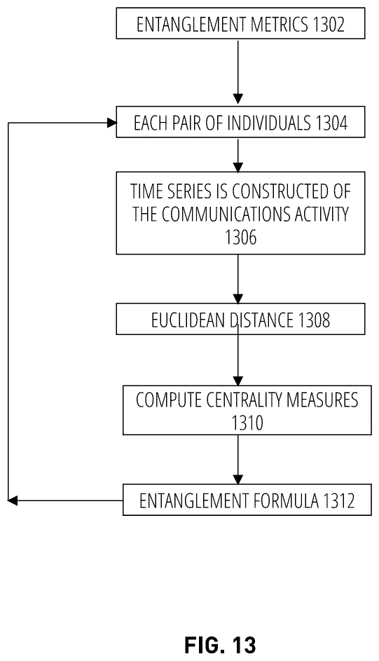

The entanglement analysis module 1104 implements the following algorithm to calculate activity entanglement, as seen in FIG. 13:

1) For each pair of individuals (x, y) in the network (each pair of individuals 1304):

a) Construct time series A(xT) and A(yT) representing their communication activity over time window T (time series is constructed of the communications activity 1306).

b) Calculate the Euclidean distance d(A(xT), A(yT)) between these time series (Euclidean distance 1308).

c) Compute the degree centralities CD(xT) and CD(yT) for both individuals (compute centrality measures 1310).

d) Calculate the activity entanglement EA(xT, yT) (entanglement formula 1312) using the formula:

$$EA ( xT , yT ) = [ CD ( xT ) * CD ( yT ) ] / d ( A ( xT ) , A ( yT ) )$$

2) Repeat the process for betweenness entanglement, using betweenness centrality time series instead of activity.

3) For group betweenness entanglement:

a) Calculate the group betweenness centralization CGBT for each time window.

b) For each individual x, calculate EGB (xT) using the formula:

$$EGB ( xT ) = CGBT / d ( CGBT , CB ( xT ) )$$

4) Calculate Gini coefficients for the distribution of entanglement scores across the network.

The system implements these calculations using efficient matrix operations and parallel processing techniques to handle large-scale networks (Gini Coefficient 1208).

### Data Preprocessing and Normalization

Before calculating entanglement metrics, the system performs several preprocessing steps:

1) Data cleaning: Removing or correcting invalid entries, handling missing data, and resolving inconsistencies in the communication records.

2) Time window selection: Dividing the data into appropriate time windows (e.g., daily, weekly) based on the analysis requirements.

3) Activity normalization: Scaling communication activity measures to account for differences in overall activity levels between individuals or time periods.

4) Graph construction: Building the social network graph representation from the communication data, including handling of multi-recipient messages and thread structures.

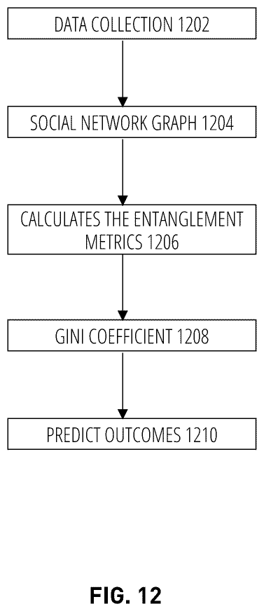

FIG. 12 shows a possible flow chart of the calculation of the entanglement metrics. This process starts with the data collection 1202. The data collection 1202 uses the data retrieval module 1102 to collect data from email servers or other communication platforms to collect electronic communication data 1114 and places it in a System Database 1412. It uses secure APIs or database queries to extract relevant metadata such as sender, recipient, timestamp, and message content.

Next, the entanglement analysis module 1104 constructs a social network graph 1204. In one embodiment, this graph is a database of nodes linking to each other. Each email or social media communication may include a record of the originator of the message, the destinations of the message, the date and time of the message, the type of message (email, LinkedIn, Facebook, a calendar entry, a meeting entry, an instant message, a text, a phone call, a video call, etc), and other pertinent information.

Next, the entanglement analysis module 1104 calculates the entanglement metrics 1206 using the formulas described in FIG. 12. In this process, the calculates the entanglement metrics 1206 step, the activity entanglement, the betweenness entanglement, and the group betweenness entanglement are determined.

Optionally, the Gini Coefficient 1208 is calculated. The performance measures 1116, the results of the Gini calculation, and the entanglement metrics, are sent to the outcome prediction module 1106 to predict outcomes 1210. The Gini Coefficient 1208 is calculated using the following formula:

$$G ( {E}_{GB} ) = \frac{{\sum }_{i = 1}^{n} {\sum }_{j = 1}^{n} \vert {E}_{GB} ( {x}_{i} ) - {E}_{GB} ( {x}_{j} ) \vert}{2 {n}^{2} \overline{{E}_{GB}}}$$

The predict outcomes 1210 step predicts team performance, individual performance, employee turnover, and customer satisfaction, as described above.

FIG. 13 is a possible flow chart showing how entanglement is calculated by the processor 1110. The process starts in a for loop for each pair of individuals 1304 calculating entanglement metrics 1302 for each pair.

A time series is constructed of the communications activity 1306 by sorting each pair by date.

Then the Euclidean distance 1308 between the time series is calculated using the following formula:

$$d ( A ( {x}_{t} ) , A ( {y}_{t} ) ) = \sqrt{{( A ( {x}_{t} ) - A ( {y}_{t} ) )}^{2}}$$

The compute centrality measures 1310 are then calculated, determining the degree and betweenness factors. The results are then applied to the entanglement formula 1312:

$${E}_{A} ( {x}_{T} , {y}_{T} ) = \frac{{C}_{D} ( {x}_{T} ) {C}_{D} ( {y}_{T} )}{d ( A ( {x}_{T} ) , A ( {y}_{T} ) )}$$

FIG. 14 is a possible hardware configuration. In this configuration, a Bus 1402 provides the exchange of data between various components. A processor 1110 may coordinate activity on the bus, retrieving Computer Instructions 1414 and data from the other devices. The processor could be a microprocessor, a system-on-a-chip, an ASIC, an optical processor, or similar device. The processor 1110 could receive instructions and data from a Touchscreen 1440, a Keyboard 1442, a Mouse 1444, a Display Interface 1438, a smartwatch, a camera, a smartphone, a tablet, a telephone, a body sensor, an Internet/Web Interface 1426, or from a Wired 1422 or Wireless 1424 network (possibly from the Cloud 1436).

The hardware configuration may include a Communications 1420 subsystem that provides a Wired 1422 and Wireless 1424 access to external devices through direct connection, local area networks, wide area networks, and the Internet or the Cloud 1436. Within the Communications 1420 subsystem could be interfaces to the Internet/Web Interface 1426 (such as support for web browsers and web servers), an Email Interface 1428 (such as ports for receiving and sending email, and an access mechanism for retrieving email databases for analysis), a Facebook Interface 1430 (providing access to a database of Facebook posts and chats), a LinkedIn Interface 1432 (that is able to retrieve the LinkedIn database of connections, chats, and posts), a Twitter Interface 1434 (with the ability to retrieve tweets and chats from X/Twitter), interfaces to a calendar, a list of meetings, instant messages, texts, phone calls, video calls, as well as access to other social media databases. In some embodiments, some or all of this functionality may be moved to the processor 1110 and Memory 1112 or remotely to a server accessible through the Wired 1422 or Wireless 1424 network interfaces.

The Memory 1112 could be made up of ROM 1404, RAM 1408, Disk Drives 1410, optical storage, and similar storage devices. The Memory 1112 could be local to the processor over the Bus 1402 or remote or any combination thereof. The Memory 1112 could include a System Database 1412 of the communication data 1114 retrieved by the data retrieval module 1102. The Memory 1112 could also include Modules 1416 such as the data retrieval module 1102, the entanglement analysis module 1104, the outcome prediction module 1106, and other modules.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I claim:

1. A computer-implemented method for measuring communication synchronization, the computer-implemented method comprising:
obtaining electronic communication data associated with a group of computing identifiers over a period of time;
determining one or more entanglement metrics for each of the computing identifiers based on the electronic communication data, wherein an entanglement metric quantifies a degree of synchronization between a communication activity pattern of the computing identifier and communication activity patterns of other computing identifiers;
wherein the entanglement metric is determined as a Euclidean distance between a vector representing the communication activity pattern of the computing identifier and vectors representing the communication activity patterns of the other computing identifiers.

2. The computer-implemented method of claim 1, wherein the entanglement metric is an activity entanglement metric calculated based on time series data representing a number of electronic messages sent or received by each of the computing identifiers over the period of the time.

3. The computer-implemented method of claim 1, wherein betweenness centrality is a measure of centrality in a social network graph based on how often a node lies on a shortest paths between other nodes, and wherein the entanglement metric is a betweenness entanglement metric determined based on time series data representing betweenness centrality values of each of the computing identifiers over the period of the time, and the Euclidean distance is determined between vectors of the betweenness centrality values.

4. The computer-implemented method of claim 1, further comprising:
determining a group betweenness centralization value for the group of computing identifiers over each time interval;
wherein the entanglement metric is a group betweenness entanglement metric calculated based on the Euclidean distance between a vector of the betweenness centrality values of the computing identifier and a vector of the group betweenness centralization values over the time intervals.

5. The computer-implemented method of claim 1, further comprising:
determining a Gini coefficient of the entanglement metrics across the computing identifiers to quantify an inequality in a distribution of the degree of synchronization among the computing identifiers of the group of computing identifiers.

6. The computer-implemented method of claim 1, further comprising:
using the entanglement metrics to predict one or more performance outcomes selected from a set consisting of: group performance, group creativity, group productivity, group learning behavior, employee turnover risk, individual employee performance, and customer satisfaction scores.

7. An apparatus for measuring communication synchronization, comprising:
a data retrieval module configured to obtain electronic communication data associated with a group of computing identifiers over a period of time;
an entanglement analysis module comprising a processor configured to:
construct a social network graph from the electronic communication data, wherein nodes of the social network graph represent the computing identifiers of the group of computing identifiers and edges represent communication links between the computing identifiers,
determine one or more entanglement metrics for each of the computing identifiers based on the electronic communication data, wherein an entanglement metric quantifies a degree of synchronization between a communication activity pattern of the computing identifier and communication activity patterns of other computing identifiers of the group of computing identifiers,
wherein the entanglement metric is determined as a Euclidean distance between a vector representing the communication activity pattern of the computing identifier and vectors representing the communication activity patterns of the other computing identifiers over the time;
an outcome prediction module configured to use the entanglement metrics to predict one or more performance outcomes.

8. The apparatus of claim 7, wherein the entanglement metric is an activity entanglement metric calculated based on time series data representing a number of electronic messages sent or received by each of the computing identifiers over the period of the time.

9. The apparatus of claim 7, wherein betweenness centrality is a measure of centrality in the social network graph based on how often a node lies on a shortest paths between other nodes, and wherein the entanglement metric is a betweenness entanglement metric calculated based on time series data representing betweenness centrality values of each of the computing identifiers over the period of the time, and the Euclidean distance is calculated between vectors of the betweenness centrality values.

10. The apparatus of claim 7, further comprising the processor configured to:
determine a group betweenness centralization value for the group of computing identifiers over each time interval;
wherein the entanglement metric is a group betweenness entanglement metric calculated based on the Euclidean distance between a vector of the betweenness centrality values of the computing identifier and a vector of the group betweenness centralization values over the time intervals.

11. The apparatus of claim 7, further comprising the processor configured to:
determine a Gini coefficient of the entanglement metrics across the computing identifiers to quantify an inequality in a distribution of the degree of synchronization among the computing identifiers of the group of computing identifiers.

12. The apparatus of claim 7, further comprising the processor configured to:
use the entanglement metrics to predict the one or more performance outcomes selected from a set consisting of: group performance, group creativity, group productivity, group learning behavior, employee turnover risk, individual employee performance, and customer satisfaction scores.

13. A non-transitory computer-readable medium storing instructions that, when executed by a processor, cause the processor to perform a method for measuring communication synchronization, the method comprising:
constructing a social network graph from electronic communication data, wherein nodes of the social network graph represent computing identifiers of a group of the computing identifiers and edges represent communication links between the computing identifiers, wherein the electronic communication data comprises at least one of emails, calendar meetings, instant messages, phone calls, or video conferences;
determining one or more entanglement metrics for each of the computing identifiers based on the electronic communication data, wherein an entanglement metric quantifies a degree of synchronization between a communication activity pattern of the computing identifier and communication activity patterns of other of the computing identifiers of the group of computing identifiers;
wherein the entanglement metric is determined as a Euclidean distance between a vector representing the communication activity pattern of the computing identifier and vectors representing the communication activity patterns of the other of the computing identifiers over time;
wherein the entanglement metrics are calculated over different time window sizes to capture varying synchronization patterns at different time scales.

14. The non-transitory computer-readable medium of claim 13, wherein the entanglement metric is an activity entanglement metric calculated based on time series data representing a number of electronic messages sent or received by each of the computing identifiers over a period of time.

15. The non-transitory computer-readable medium of claim 13, wherein betweenness centrality is a measure of centrality in the social network graph based on how often a node lies on a shortest paths between other nodes, and wherein the entanglement metric is a betweenness entanglement metric calculated based on time series data representing betweenness centrality values of each of the computing identifiers over a period of time, and the Euclidean distance is calculated between vectors of the betweenness centrality values.

16. The non-transitory computer-readable medium of claim 13, further comprising:
determining a group betweenness centralization value for the group of computing identifiers over each time interval;
wherein the entanglement metric is a group betweenness entanglement metric calculated based on the Euclidean distance between a vector of the betweenness centrality values of the computing identifier and a vector of the group betweenness centralization values over the time intervals.

17. The non-transitory computer-readable medium of claim 13, further comprising:
calculating a Gini coefficient of the entanglement metrics across the computing identifiers to quantify an inequality in a distribution of the degree of synchronization among the computing identifiers of the group of computing identifiers.

18. The non-transitory computer-readable medium of claim 13, further comprising:
using the entanglement metrics to predict one or more performance outcomes selected from a set consisting of: group performance, group creativity, group productivity, group learning behavior, employee turnover risk, individual employee performance, and customer satisfaction scores.
